(19) United States
(12) Patent Application Publication
(10) Pub. No.: US 2006/0271610 A1
(43) Pub. Date: Nov. 30, 2006

(54) Digital signal processor having reconfigurable data paths

(75) Inventors: Seung Eun Lee, Sungnam (KR); Yong Mu Jeong, Sungnam (KR); Jong Chan Choi, Sungnam (KR)

Correspondence Address: SUGHRUE MION, PLLC, 2100 PENNSYLVANIA AVENUE, N.W., SUITE 800, WASHINGTON, DC, 20037, US

(73) Assignee: Korea Electronics Technology Institute

(21) Appl. No.: 11/192,006

(22) Filed: Jul. 29, 2005

(30) Foreign Application Priority Data
May 27, 2005 (KR) KR10-2005-0045063

(51) Int. Cl. G06F 15/00

(52) U.S. Cl. 708/200

(57) ABSTRACT

Disclosed herein is a Digital Signal Processor (DSP) having reconfigurable data paths necessary for processing for a specific use. The DSP includes a plurality of Arithmetic Logic Units (ALUs), pairs of input multiplexers, an output multiplexer, and a reconfiguration control unit. The plurality of ALUs performs unit operations. Each of the pairs of input multiplexers selects data, which will be input to a corresponding ALU, from among input data directed to operate by an instruction word, and output data of the ALUs. The output multiplexer selects one from among the output data of the ALUs, and outputs the selected output data. The reconfiguration control unit controls the data selections of the output multiplexer and the input multiplexers.

### RELATED APPLICATIONS

The present disclosure relates to subject matter contained in priority Korean Application No. 10-2005-0045063, filed on 27 May 2005, which is herein expressly incorporated by reference in its entirety.

### BACKGROUND OF THE INVENTION

1. Field of the Invention

The present invention relates generally to a high-performance digital signal processor and, more particularly, to the reconfigurable structure of a digital signal processor, which reconfigures data paths according to an application field, thus being applicable to a high-performance signal processing system.

2. Description of the Related Art

Generally, a Digital Signal Processor (DSP) includes data paths to perform signal processing and operations. The operations are performed through the data paths.

FIG. 1 is a block diagram of a conventional Very Long Instruction Word (VLIW)-based parallel processing DSP. As shown in FIG. 1, the parallel processing DSP includes a control unit 120 for performing control so as to receive instructions from program memory (not shown) via a program bus 110 and perform operations according to the instructions, an address generation unit 130 for performing address operations according to the instructions interpreted by the control unit 120, a data arithmetic unit 140 for performing data operations according to the instructions interpreted by the control unit 120, and a data bus 150 for allowing data to be exchanged between the control unit 120 and the address generation unit 130 or between the control unit 120 and the data arithmetic unit 140.

The control unit 120 includes a program counter 122 for storing addresses for instructions being executed, status registers and loop registers 124 for storing information about the internal status of the DSP and a pointer value, that is, a reference value for an instruction loop, and an instruction decoder 126 for interpreting instructions and extracting operations to be performed, and addresses or data to be used for the operations.

The address generation unit 130 includes N Address Arithmetic Units (AAUs) 132_1, 132_2, . . . , and 132_N, which are sub units, for performing address operations, and, therefore, N address operations can be simultaneously performed. Furthermore, the address generation unit 130 includes an address register file 134 for storing addresses necessary for address operations and the operation results thereof.

The data arithmetic unit 140 includes M data path units 142_1, 142_2, . . . , and 142_M, which are sub units, and, therefore, it can performs a maximum of M logic operations. Furthermore, the data arithmetic unit 140 additionally includes a register file 144 for storing addresses necessary for address operations and the operation results thereof, similarly to the above-described address generation unit 130. The data path units 142_1, 142_2, . . . , and 142_M configure data paths between logic arithmetic units that are provided inside the data arithmetic unit 140 so that a specific operation can be performed using data stored in the register file 144.

The operation of the DSP is described below. First, an instruction interpreter 126 interprets instructions read from the program memory, and data directed to operate by the instructions are loaded from data memory (not shown) into an internal register file 144. Data operations are performed along the data paths of the interior of the data path units 142_1, 142_2, . . . , and 142_M based on the data of the register file 144.

However, the above-described conventional DSP includes previously designed, fixed data paths according to an instruction set and the application field thereof. For example, in order to process instructions, the data paths of the conventional DSP includes Arithmetic Logic Units (ALUs), such as a multiplier, a shifter, an adder, a comparator, a minimum/maximum operation unit, and a logical operation unit, that is, an AND/OR/XOR/NOT operation unit, which are contained in the DSP in the forms of fixed circuits depending on the use thereof.

FIG. 2 is a diagram illustrating an example of a data path fixed as described above.

As shown in FIG. 2, for example, in the data path for performing Multiplication-and-Accumulation (MAC) operations, data output from a register file (144 of FIG. 1) may be passed through a multiplier 210 and a left shifter 220, that is, a 1-bit left shifter, and the accumulation operation of the data may be performed by an ALU 230. That is, in accordance with the data path, accumulation after multiplication can be performed through a single data path, but two data path operations are required for processing multiplication after accumulation.

As described above, in the conventional DSP structure, data path is previously fixed, so that only a predefined type of operation can be performed along the data path in a single clock cycle, and operations other than the predefined operation must be performed for a number of clock cycles. That is, in the conventional DSP structure, the lack of flexibility depending on the type of operations is a problem that must be solved as soon as possible.

### SUMMARY OF THE INVENTION

Accordingly, the present invention has been made keeping in mind the above problems occurring in the prior art, and an object of the present invention resides in constructing a DSP such that the sequence of detailed logic operations required for the data paths of the DSP can be dynamically rearranged, thus increasing the number of instructions that can be processed by the DSP in a single clock cycle, thereby improving the performance of the DSP.

In order to accomplish the above object, the present invention provides a DSP capable of reconfiguring data paths, the DSP including a plurality of Arithmetic Logic Units (ALUs) for performing unit operations; pairs of input multiplexers for each pair selecting data to be input to a corresponding one of the ALUs, from among input data directed to operate by an instruction word, and output data of the plurality of ALUs; an output multiplexer for selecting one from among the output data of the ALUs, and outputting the selected output data; and a reconfiguration control unit for controlling the data selections of the output multiplexer and the pairs of input multiplexers.

Preferably, the reconfiguration control unit controls the data selections of the output multiplexer and the pairs of input multiplexers in a single clock cycle so that a plurality of unit operations are performed on the input data.

More Preferably, each of the input multiplexers selects data to be input to the corresponding ALU, from among three or more pieces of input data directed to operate by the instruction word, and output data of the ALUs.

In addition, the present invention provides a data path device, capable of reconfiguring data paths of a plurality of ALUs, each of which performs a unit operation, in a digital signal processor. The data path device including pairs of input multiplexers for each pair selecting data to be input to a corresponding one of the ALUs, from among input data directed to operate by an instruction word, and output data of the ALUs; an output multiplexer for selecting one from among the output data of the ALUs, and outputting the selected output data; and a reconfiguration control unit for controlling the data selections of the output multiplexer and the pairs of input multiplexers.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of a conventional VLIW-based parallel processing DSP;

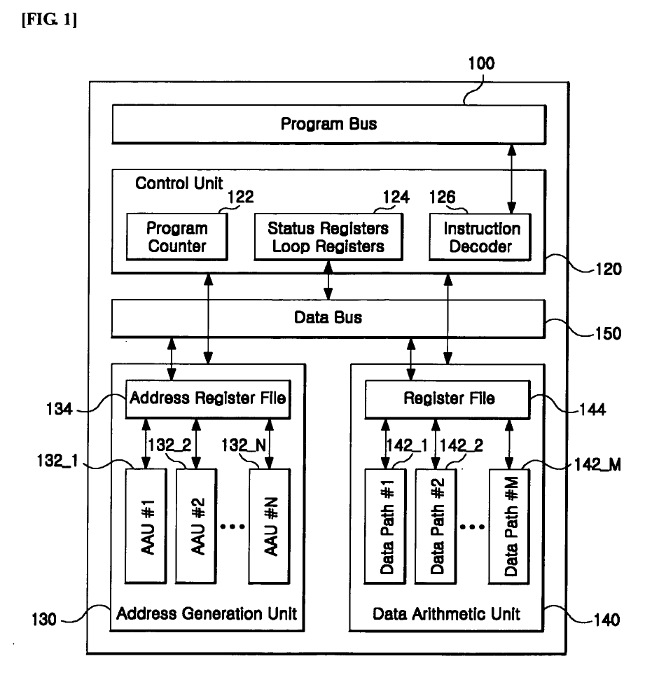

FIG. 2 is a diagram illustrating an example of a fixed data path in the DSP of FIG. 1;

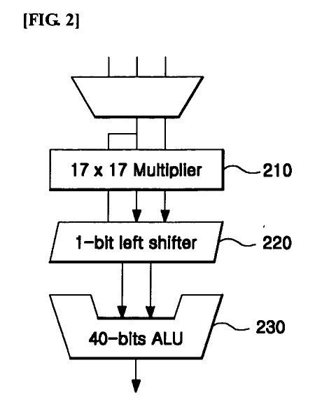

FIG. 3 is a diagram illustrating an example of a data path device (or data path unit) that provides the reconfigurable data path of the interior of the DSP according to a preferred embodiment of the present invention; and

FIG. 4 is a diagram illustrating an example of ALUs connected to the data path device of FIG. 3.

### DESCRIPTION OF THE PREFERRED EMBODIMENTS

A preferred embodiment of the present invention is described with reference to the accompanying drawings below.

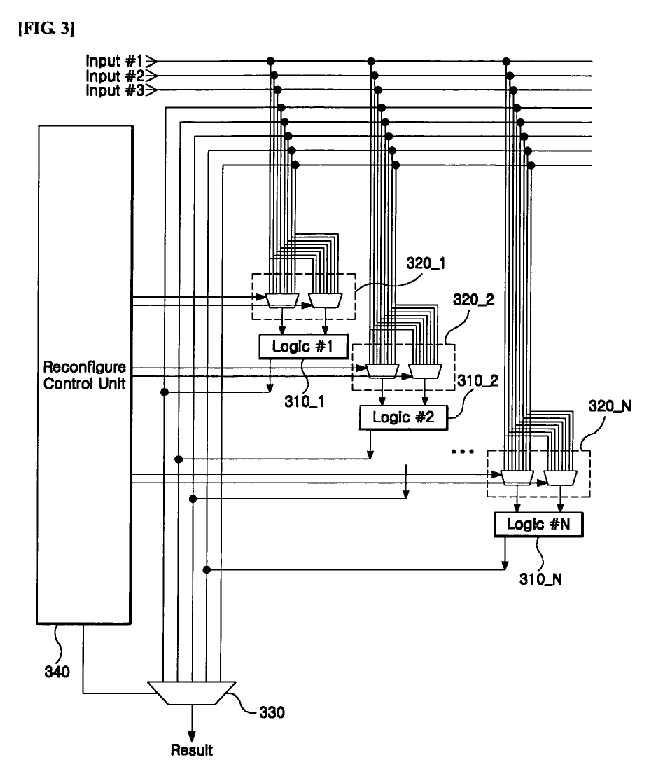

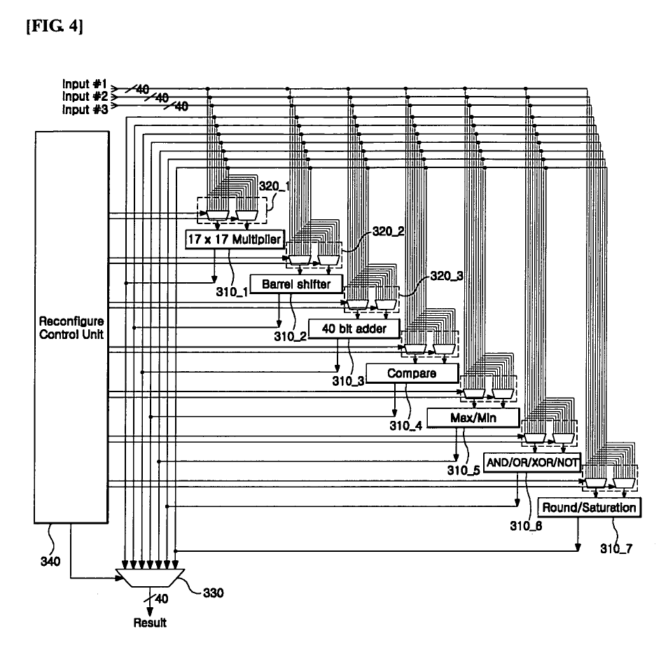

FIG. 3 is a diagram illustrating an example of a data path device that provides reconfigurable data paths between a plurality of ALUs according to the preferred embodiment of the present invention, in which the data path device may be provided inside a DSP or a reconfigurable chip. FIG. 4 is a diagram illustrating an specific example of ALUs connected to the data path device of FIG. 3.

Referring to FIG. 3, the data path device provided with reconfigurable data paths according to the preferred embodiment of the present invention includes a plurality of ALUs 310_1, 310_2, . . . , and 310_N for performing unit operations, pairs of input multiplexers 320_1, 320_2, . . . , and 320_N for each pair selecting data, which will be input to a corresponding one of the ALUs, from among input data and the output data of the ALUs 310_1, 310_2, . . . , and 310_N and outputting the selected data, an output multiplexer 330 for selecting one from among the output data of the ALUs 310_1, 310_2, . . . , and 310_N and outputting the selected output data, and a reconfiguration control unit 340 for controlling the data selection of the output multiplexer 330 and the pairs of input multiplexers 320_1, 320_2, . . . , and 320_N.

The ALUs 310_1, 310_2, . . . , and 310_N perform unit operations. For example, the plurality of ALUs 310_1, 310_2, . . . , and 310_N, as shown in FIG. 4, may include a multiplier 310_1, a shifter 310_2, that is, a Barrel shifter, an adder 310_3, a comparator 310_4, a maximum/minimum operation unit 310_5, a logic arithmetic unit 310_6, that is, an AND/OR/XOR/NOT operation unit, and a round/saturation operation unit 310_7. Each pair of input multiplexers 320_1, 320_2, . . . , and 320_N are connected to the input terminals of the corresponding ALU 310_1, 310_2, . . . , and 310_N.

Referring to FIG. 3 again, three pieces of input data Input #1, Input #2 and Input #3, which are accessed from the above-described register file (not shown), and data, which are output from the ALUs 320_1, 320_2, . . . , and 320_N, are input to the pairs of input multiplexers 320_1, 320_2, . . . , and 320_N. And, each multiplexer of the input multiplexer pairs may select a single piece of data which will be input to the corresponding ALU, in response to a control signal received from the reconfiguration control unit 340.

The output multiplexer 330 selects one from among the data output from the plurality of ALUs 320_1, 320_2, . . . , and 320_N in response to the control signal received from the reconfiguration control unit 340.

The reconfiguration control unit 340 may be configured such that data selections of the output multiplexer and the input multiplexers described above are simultaneously controlled, an operation result performed by a specific ALU can be used for the input of different ALUs, and a final operation result is selected and output. For example, in the case of the pair of input multiplexer 320_1 corresponding to the multiplier 310_1 shown in FIG. 4, two pieces of data can be selected from among the three pieces of input data Input #1, Input #2 and Input #3 the operation of each of which is directed by a single instruction word, and the selected data can be input to the multiplier 310_1. Data output from the multiplier 310_1 are input to the respective input multiplexers, so that further operations can be subsequently performed.

Meanwhile, the reconfiguration control unit 340 controls data selections of the output multiplexer and the pairs of input multiplexers in a single clock cycle according to an instruction interpreted by an instruction decoder, thus being capable of processing a VLIW-based instruction in a single clock cycle.

As described above, the data paths of FIG. 3 are reconfigured in such a manner that the input and output of the ALUs are selected using the multiplexers, and these multiplexers are under the control of the control unit. Accordingly, the data paths of the ALUs can be reconfigured.

The operation of the reconfigurable data paths illustrated in FIG. 4 is described using several instructions below.

1. Inst1 Aa, Ab, An (An=Aa*Ab+An)

For the Inst1 operation, Data paths, including the multiplier 310_1 and the adder 310_3, are configured. In this case, the multiplier 310_1 selects Aa and Ab from among input data Aa, Ab and An (corresponding to Input #1, Input #2 and Input #3 of FIG. 3, respectively) the operation of each of which is directed by a single instruction word. Meanwhile, the adder 310_3 receives a multiplier output value and the input data An, which are selected by the pair of input multiplexers 320_3, and performs summation operation. The final operation result of the adder 310_3 is selected by the output multiplexer 330 and is then output. When a round or saturation operation is requested, the round/saturation operation unit 310_7 may be included as the next data path of the adder 310_3.

2. Inst2 Aa, Ab, An An=Aa AND Ab+An

For the Inst2 operation, data paths, including the logic arithmetic unit 310_6 and the adder 310_3, are configured. In this case, the logic arithmetic unit 310_6 selects Aa and Ab from among input data Aa, Ab and An input from the register file. Meanwhile, the adder 310_3 receives the output data of the logic arithmetic unit 310_6 and the input data An as input data, and then performs a corresponding operation. The result of the performed operation is selected by the output multiplexer 330.

Meanwhile, in the above-described embodiment, the input data Input #1, Input #2 and Input #3 and the input data and output data of the ALUs 320_1, 320_2, . . . , and 320_N may be each composed of a plurality of bits. For example, with reference to FIG. 4, the input data Input #1, Input #2 and Input #3 are each composed of 40 bits, and it will be appreciated by those skilled in the art that the respective input and output data of the respective ALUs may be composed of a plurality of bits so as to correspond to that of the input data Input #1, Input #2 and Input #3.

Furthermore, the data path device according to the present invention may be applied to a VLIW-based instruction set. In this case, a plurality of unit operations can be performed on three or more pieces of data input from the register file in a single clock cycle.

As described above, in accordance with the present invention, logic units, included in data paths, are reconfigured in real time according to instructions, so that flexibility can be granted to the DSP and the performance of the DSP can be improved. Accordingly, data paths necessary for processing for a specific use can be reconfigured in real time, so that a high-performance signal processor can be implemented.

Furthermore, the DSP, including reconfigurable data paths proposed according to the present invention, uses data paths, which are reconfigured according to the instructions of the DSP, through the reconfiguration of its internal operation units, so that instructions can be performed in a single clock cycle, and the reconfiguration of an instruction set can be supported.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A Digital Signal Processor (DSP) capable of reconfiguring data paths, the DSP comprising:
A plurality of Arithmetic Logic Units (ALUs) for performing unit operations;
pairs of input multiplexers for each pair selecting data to be input to a corresponding one of the ALUs, from among input data directed to operate by an instruction word, and output data of the ALUs;
an output multiplexer for selecting one from among the output data of the ALUs, and outputting the selected output data; and
a reconfiguration control unit for controlling the data selections of the output multiplexer and the pairs of input multiplexers.

2. The DSP as set forth in claim 1, wherein the reconfiguration control unit controls the data selections of the output multiplexer and the pairs of input multiplexers in a single clock cycle so that a plurality of unit operations are performed on the input data.

3. The DSP as set forth in claim 2, wherein each of the input multiplexers selects data to be input to the corresponding ALU, from among three or more pieces of input data directed to operate by the instruction word, and output data of the ALUS.

4. A data path device, capable of reconfiguring data paths of a plurality of ALUs, each of which performs a unit operation, in a digital signal processor, the device comprising:
pairs of input multiplexers for each pair selecting data to be input to a corresponding one of the ALUS, from among input data directed to operate by an instruction word, and output data of the plurality of ALUS;
an output multiplexer for selecting one from among the output data of the ALUs, and outputting the selected output data; and
a reconfiguration control unit for controlling the data selections of the output multiplexer and the pairs of input multiplexers.

5. The data path device as set forth in claim 4, wherein the reconfiguration control unit controls the data selections of the output multiplexer and the pairs of input multiplexers in a single clock cycle so that a plurality of unit operations is performed on the input data.

6. The data path device as set forth in claim 5, wherein each of the input multiplexers selects data to be input to the corresponding ALU, from among three or more pieces of input data directed to operate by the instruction word, and output data of the plurality of ALUs.
